(19) United States
(12) Patent Application Publication
(10) Pub. No.: US 2024/0406521 A1
(43) Pub. Date: Dec. 5, 2024

(54) Content System with Summary-Based Content Generation Feature

(71) Applicant: Roku, Inc., San Jose, CA (US)

(72) Inventors: Sunil Ramesh, Cupertino, CA (US); Michael Cutter, Golden, CO (US); Karina Levitian, Austin, TX (US)

(21) Appl. No.: 18/328,560

(22) Filed: Jun. 2, 2023

(51) Int. Cl. H04N 21/8549; H04N 21/235; H04N 21/845

(52) U.S. Cl. CPC H04N 21/8549; H04N 21/235; H04N 21/8456

(57) ABSTRACT

In one aspect, an example method includes (i) obtaining first media content; (ii) obtaining plot data associated with the obtained first media content; (iii) obtaining user profile data associated with a user; (iv) identifying from the obtained first media content, a first set of segments; (v) using at least the obtained plot data, the obtained user profile data, and segment data associated with each segment, to determine segment relevance data for each such segment; (vi) using at least the determined segment relevance data for the segments as a basis to select, from among the identified first set of segments, a second set of segments; (vii) using at least the selected second set of segments to generate second media content, wherein the generated second media content is shorter in duration than the obtained first media content; and (viii) outputting for presentation the generated second media content.

### USAGE AND TERMINOLOGY

In this disclosure, unless otherwise specified and/or unless the particular context clearly dictates otherwise, the terms “a” or “an” mean at least one, and the term “the” means the at least one.

### SUMMARY

In one aspect, an example method is disclosed. The method includes (i) obtaining first media content that includes a video content component; (ii) obtaining plot data associated with the obtained first media content; (iii) obtaining user profile data associated with a user; (iv) identifying from the obtained first media content, a first set of segments; (v) using at least (a) the obtained plot data, (b) the obtained user profile data, and (c) segment data associated with each segment of the identified first set of segments, to determine segment relevance data for each such segment; (vi) using at least the determined segment relevance data for the segments in the identified first set of segments as a basis to select, from among the identified first set of segments, a second set of segments having fewer segments than the first set of segments; (vii) using at least the selected second set of segments to generate second media content that includes a video content component, wherein the generated second media content is shorter in duration than the obtained first media content; and (viii) outputting for presentation the generated second media content.

In another aspect, an example computing system is disclosed. The computing system is configured for performing a set of acts that includes (i) obtaining first media content that includes a video content component; (ii) obtaining plot data associated with the obtained first media content; (iii) obtaining user profile data associated with a user; (iv) identifying from the obtained first media content, a first set of segments; (v) using at least (a) the obtained plot data, (b) the obtained user profile data, and (c) segment data associated with each segment of the identified first set of segments, to determine segment relevance data for each such segment; (vi) using at least the determined segment relevance data for the segments in the identified first set of segments as a basis to select, from among the identified first set of segments, a second set of segments having fewer segments than the first set of segments; (vii) using at least the selected second set of segments to generate second media content that includes a video content component, wherein the generated second media content is shorter in duration than the obtained first media content; and (viii) outputting for presentation the generated second media content.

In another aspect, an example non-transitory computer-readable medium is disclosed. The computer-readable medium has stored thereon program instructions that upon execution by a processor of a computing system, cause performance of a set of acts that includes (i) obtaining first media content that includes a video content component; (ii) obtaining plot data associated with the obtained first media content; (iii) obtaining user profile data associated with a user; (iv) identifying from the obtained first media content, a first set of segments; (v) using at least (a) the obtained plot data, (b) the obtained user profile data, and (c) segment data associated with each segment of the identified first set of segments, to determine segment relevance data for each such segment; (vi) using at least the determined segment relevance data for the segments in the identified first set of segments as a basis to select, from among the identified first set of segments, a second set of segments having fewer segments than the first set of segments; (vii) using at least the selected second set of segments to generate second media content that includes a video content component, wherein the generated second media content is shorter in duration than the obtained first media content; and (viii) outputting for presentation the generated second media content.

### BRIEF DESCRIPTION OF THE DRAWINGS

FIG. 1 is a simplified block diagram of an example content system in which various described principles can be implemented.

FIG. 2 is a simplified block diagram of an example computing system in which various described principles can be implemented.

FIG. 3 is a simplified diagram illustrating an example set of segments identified from example media content.

FIG. 4 is a simplified diagram illustrating example plot relevance data.

FIG. 5 is a simplified diagram illustrating example user relevance data.

FIG. 6 is a simplified diagram illustrating example generated media content.

FIG. 7 is a flow chart of an example method.

FIG. 8 is a flow chart of another example method.

### DETAILED DESCRIPTION

### I. Overview

After a content provider produces media content, it might be desirable for the media provider to then generate a shortened, summarized version of that media content. For example, in the case where the media content is a two-hour movie, it might be desirable for the media provider to generate a corresponding ninety-second movie trailer, which can be used for promotional purposes, among other things. However, the process for generating a movie trailer or other type of summarized media content can be slow and can involve lots of manual and tedious user-controlled editing activity.

In addition, given the increasingly large amount of trailers and other media content that is now available to users, it has become especially important for content providers to provide media content that users find interesting and engaging, so that users will choose that media content over other options. In the context of trailers and other summarized media content, one way to do this is by providing a given user with summarized media content that is personalized specifically for that user.

Examples of the disclosed systems and methods help address these and other issues by, among other things, facilitating efficient generation of summarized media content that is personalized for a given user. In one aspect, related operations can be carried out by a content generator. The content generator can begin by obtaining first media content that includes a video content component (e.g., a movie). The content generator can then obtain plot data associated with the obtained first media content For example, the plot data for media content can be text summarizing a plot of the media content.

Next, the content generator can obtain user profile data associated with a user for whom generated summarized media content is intended to be presented to. The user profile data can include preference data that indicates content-related preferences for that user. For example, the preference data could include genre preference data that indicates one or more genre types (e.g., action, adventure, comedy, or romance) that the user prefers. As another example, the preference data could include actor/actress preference data that indicates one or more actors or actresses that the user prefers.

Next, the content generator can identify from the obtained first media content, a first set of segments (e.g., a set of scenes of the movie). The content generator can then use at least the obtained plot data, the obtained user profile data, and segment data associated with each segment of the identified first set of segments, to determine segment relevance data for each such segment. Segment data can include various data related to a given segment. For example, segment data may include descriptive information about the content of the segment and could indicate, for example, who is in the scene, what happens in the scene, what dialog is spoken, what sound effects or music accompany the scene, among numerous other possibilities. The segment relevance data can have one or more different components, including plot relevance data and user relevance data, which can indicate the degree to which each segment is relevant to the plot and/or to the user.

The content generator can then use at least the determined segment relevance data for the segments in the identified first set of segments as a basis to select, from among the identified first set of segments, a second set of segments having fewer segments than the first set of segments (e.g., few scenes of the movie as compared to those that were initially identified). Next, the content generator can use at least the selected second set of segments to generate second media content that includes a video content component, where the generated second media content is shorter in duration than the obtained first media content.

This generated second media content can thus represent a summarized and personalized version of the obtained first media content. For instance, in the case where the obtained first media content is a movie, the generated second media content can be a trailer for that movie, and that is personalized specifically for the user associated with the user profile data referenced above. The content generator can then output for presentation the generated second media content (e.g., via a presentation device, such as a television).

These and related operations and features will now be described in greater detail.

### II. Example Architecture

### A. Content System

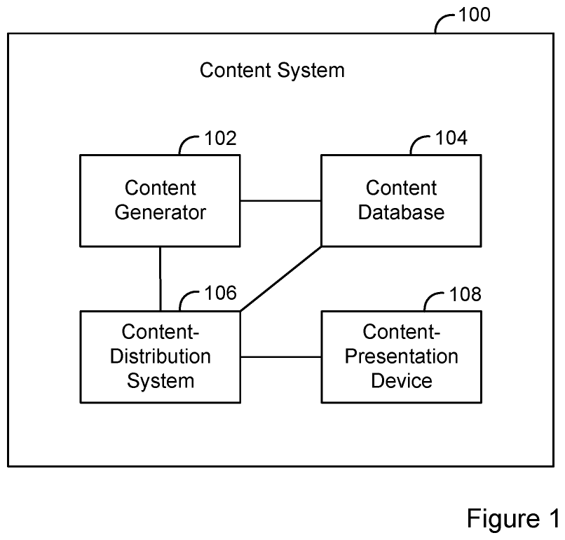

FIG. 1 is a simplified block diagram of an example content system 100. Generally, the content system 100 can perform operations related to various types of content, such as media content, which can take the form of video content and/or audio content. As such, the media content can include a video content component and/or an audio content component. For context, there can be various types of media content. For example, media content can be or include a movie, a television program, or a commercial, or a portion or combination thereof, among numerous other possibilities.

Media content can be represented by media data, which can be generated, stored, and/or organized in various ways and according to various formats and/or protocols, using any related techniques now know or later discovered. For example, the media content can be generated by using a camera, a microphone, and/or other equipment to capture or record a live-action event. In other example, the media content can be synthetically generated, such as by using one or more of the techniques described in this disclosure, or by using any related media content generation techniques now know or later discovered.

As noted above, media data can also be stored and/or organized in various ways. For example, the media data can be stored and organized as a Multimedia Database Management System (MDMS) and/or in various digital file formats, such as the MPEG-4 format, among numerous other possibilities.

The media data can represent the media content by specifying various properties of the media content, such as video properties (e.g., luminance, brightness, and/or chrominance values), audio properties, and/or derivatives thereof. In some instances, the media data can be used to generate the represented media content. But in other instances, the media data can be a fingerprint or signature of the media content, which represents the media content and/or certain characteristics of the media content and which can be used for various purposes (e.g., to identify the media content or characteristics thereof), but which is not sufficient at least on its own to generate the represented media content.

In some instances, media content can include metadata associated with the video content and/or audio content. In the case where the media content includes video content and audio content, the audio content is generally intended to be presented in sync together with the video content. To help facilitate this, the media data can include metadata that associates portions of the video content with corresponding portions of the audio content. For example, the metadata can associate a given frame or frames of video content with a corresponding portion of audio content. In some cases, audio content can be organized into one or more different channels or tracks, each of which can be selectively turned on or off, or otherwise controlled.

In some instances, media content can be made up one or more segments. For example, in the case where the media content is a movie or a television program, the media content may be made up of multiple segments, each representing a scene of the movie or television program. In various examples, a segment can be a smaller or larger portion of the media content.

Returning back to the content system 100, this can include various components, such as a content generator 102, a content database 104, a content-distribution system 106, and/or a content-presentation device 108. The content system 100 can also include one or more connection mechanisms that connect various components within the content system 100. For example, the content system 100 can include the connection mechanisms represented by lines connecting components of the content system 100, as shown in FIG. 1.

In this disclosure, the term “connection mechanism” means a mechanism that connects and facilitates communication between two or more components, devices, systems, or other entities. A connection mechanism can be or include a relatively simple mechanism, such as a cable or system bus, and/or a relatively complex mechanism, such as a packet-based communication network (e.g., the Internet). In some instances, a connection mechanism can be or include a non-tangible medium, such as in the case where the connection is at least partially wireless. In this disclosure, a connection can be a direct connection or an indirect connection, the latter being a connection that passes through and/or traverses one or more entities, such as a router, switcher, or other network device. Likewise, in this disclosure, a communication (e.g., a transmission or receipt of data) can be a direct or indirect communication.

In some instances, the content system 100 can include multiple instances of at least some of the described components. The content system 100 and/or components thereof can take the form of a computing system, an example of which is described below.

### B. Computing System

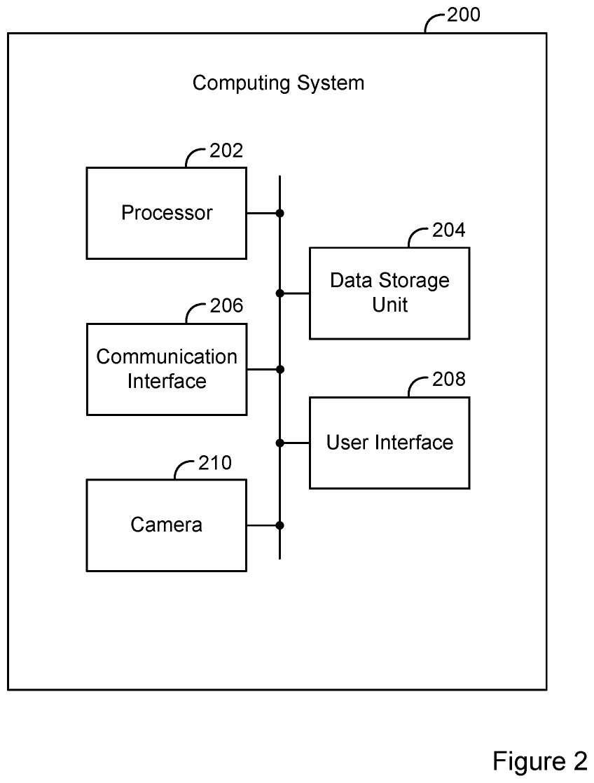

FIG. 2 is a simplified block diagram of an example computing system 200. The computing system 200 can be configured to perform and/or can perform various operations, such as the operations described in this disclosure. The computing system 200 can include various components, such as a processor 202, a data storage unit 204, a communication interface 206, a user interface 208, and/or a camera 210.

The processor 202 can be or include a general-purpose processor (e.g., a microprocessor) and/or a special-purpose processor (e.g., a digital signal processor). The processor 202 can execute program instructions included in the data storage unit 204 as described below.

The data storage unit 204 can be or include one or more volatile, non-volatile, removable, and/or non-removable storage components, such as magnetic, optical, and/or flash storage, and/or can be integrated in whole or in part with the processor 202. Further, the data storage unit 204 can be or include a non-transitory computer-readable storage medium, having stored thereon program instructions (e.g., compiled or non-compiled program logic and/or machine code) that, upon execution by the processor 202, cause the computing system 200 and/or another computing system to perform one or more operations, such as the operations described in this disclosure. These program instructions can define, and/or be part of, a discrete software application.

In some instances, the computing system 200 can execute program instructions in response to receiving an input, such as an input received via the communication interface 206 and/or the user interface 208. The data storage unit 204 can also store other data, such as any of the data described in this disclosure.

The communication interface 206 can allow the computing system 200 to connect with and/or communicate with another entity according to one or more protocols. Therefore, the computing system 200 can transmit data to, and/or receive data from, one or more other entities according to one or more protocols. In one example, the communication interface 206 can be or include a wired interface, such as an Ethernet interface or a High-Definition Multimedia Interface (HDMI). In another example, the communication interface 206 can be or include a wireless interface, such as a cellular or WI-FI interface.

The user interface 208 can allow for interaction between the computing system 200 and a user of the computing system 200. As such, the user interface 208 can be or include an input component such as a keyboard, a mouse, a remote controller, a microphone, and/or a touch-sensitive panel. The user interface 208 can also be or include an output component such as a display device (which, for example, can be combined with a touch-sensitive panel) and/or a sound speaker.

The camera 210 can be any type of camera (e.g., a webcam) configured to capture image and/or video content data.

The computing system 200 can also include one or more connection mechanisms that connect various components within the computing system 200. For example, the computing system 200 can include the connection mechanisms represented by lines that connect components of the computing system 200, as shown in FIG. 2.

The computing system 200 can include one or more of the above-described components and can be configured or arranged in various ways. For example, the computing system 200 can be configured as a server and/or a client (or perhaps a cluster of servers and/or a cluster of clients) operating in one or more server-client type arrangements, such as a partially or fully cloud-based arrangement, for instance.

As noted above, the content system 100 and/or components of the content system 100 can take the form of a computing system, such as the computing system 200. In some cases, some or all of these entities can take the form of a more specific type of computing system, such as a desktop or workstation computer, a laptop, a tablet, a mobile phone, a television, a set-top box, a streaming media device, and/or a head-mountable display device (e.g., virtual-reality headset or an augmented-reality headset), among numerous other possibilities.

### III. Example Operations

The content system 100, the computing system 200, and/or components of either can be configured to perform and/or can perform various operations. As noted above, the content system 100 can perform operations related to content summarization. In one aspect, this can involve the content system 100 (i) obtaining first media content that includes a video content component; (ii) obtaining plot data associated with the obtained first media content; (iii) obtaining user profile data associated with a user; (iv) identifying from the obtained first media content, a first set of segments; (v) using at least (a) the obtained plot data, (b) the obtained user profile data, and (c) segment data associated with each segment of the identified first set of segments, to determine segment relevance data for each such segment; (vi) using at least the determined segment relevance data for the segments in the identified first set of segments as a basis to select, from among the identified first set of segments, a second set of segments having fewer segments than the first set of segments; (vii) using at least the selected second set of segments to generate second media content that includes a video content component, wherein the generated second media content is shorter in duration than the obtained first media content; and (viii) outputting for presentation the generated second media content. These and related operations will now be described in greater detail.

### A. Obtaining First Media Content

To begin, the content generator 102 can obtain first media content, which can include a video content component and/or an audio content component. For example, the media content can be a movie or television program that includes a video content component and a corresponding audio content component.

The content generator 102 can obtain media content, such as the first media content, in various ways. In one example, the content generator 102 can obtain media content by selecting media content based on input received from a user via a user interface, and then obtaining the selected media content. In another example, the content generator 102 can do this by automatically selecting media content based on one or more predefined rules, and then obtaining the selected media content. The content generator 102 can then obtain the selected media content in various ways, such as by retrieving from a media content database such as the content database 104, media data representing the selected media content.

### B. Obtaining Plot Data

The content generator 102 can obtain plot data associated with the first media content. Plot data can take various forms. For example, the plot data for media content can be or include one or more instances of text summarizing a plot of the media content (sometimes referred to as a synopsis or storyline, or in other ways). In some examples, the plot data can be more structured and/or can provide additional information. For example, the plot data could indicate that the plot has multiple plot points, and it could include a separate portion of text summarizing each of the respective plot points, perhaps with a reference to time periods or other markers, to indicate what portions of the media content relates to what plot points. In other examples, the plot data could specify a type of a given plot, such as a macro plot that generally related to a relatively large portion of the media content, and/or several micro plots, each of which may relate to a relatively smaller portion of the media content, again perhaps with a reference to time periods or other markers. The plot data could also specify which portions of the plot are deemed to be more significant, less significant, etc. with importance scores (e.g., a score within a given range, such as from 1-100) or the like. These are just some examples forms of plot data. Numerous other examples and variations are possible as well.

As noted above, media content can have associated metadata. In some instances, plot data can be an example of that metadata. As such, in one example, the content generator 102 can obtain not only media content, but also its associated metadata (including the plot data), such as from the content database 104. In other examples, the content generator 102 can use a content title, identifier, or other information associated with the media content as a basis to lookup plot data from another source, such as an online database of media content metadata. In other examples, the content generator 102 can use a content title, identifier, or other information associated with the media content as a basis to search for and obtain plot data (e.g., from news articles written about the media content, from social media pages where the plot of the media content is discussed, etc.).

### C. Obtaining User Profile Data

The content generator 102 can then obtain user profile data associated with a user. In practice, the user is likely to be a person for whom media content (e.g., a trailer of a movie or television program) is being generated for. There can be various types of user profile data. For example, the user profile data can include preference data that indicates content-related preferences for that user. For example, the preference data could include genre preference data that indicates one or more genre types (e.g., action, adventure, comedy, or romance) that the user prefers. As another example, the preference data could include actor/actress preference data that indicates one or more actors or actresses that the user prefers. There can be many other types of preference data as well, including preference data related to any aspect of media content (e.g., preferences related to plot types, writers, directors, settings, art styles, release dates, budgets, ratings, and/or reviews, among numbers of possibilities).

Preference data can be represented in various ways. For instance, preference data can be represented with one or more scores (e.g., from 0-100) being assigned to each of multiple different potential preferences to indicate a degree or confidence score of each one, with 0 being the lowest and 100 being the highest, as just one example. For instance, in the case where the preference data indicates genre type preferences, the preference data could indicate a score of 96 for action, a score of 82 for adventure, a score of 3 for comedy, a score of 18 for romance, and so on. As such, the score of 96 for action can indicate that the user generally has a strong preference for media content of the action genre. Similarly, the score of 82 for adventure can indicate that the user also generally has a strong preference for media content of the adventure genre, though not quite as strong as a preference as compared to the action genre. And so on for each of the other genres.

Aside from user preference data, there can be other types of user profile data as well. For example, user profile data can include demographic information, language preference information, or content viewing history information of the user, among numerous other possibilities. In some instances, viewing history information could indicate various user activity in connection with media content and/or portions thereof. For example, user profile data could indicate which movies or television programs a user has watched, how often, etc. In another example, user profile data could indicate an extent to which the user has replayed or paused certain media content, or a segment thereof, which might indicate a certain level of interest in that portion. Such user profile data can be obtained, stored, organized, and retrieved in various ways, such as by using any related user profile data techniques now known or later discovered. In some instances, user profile data can be obtained, stored, and/or used after the user has provided explicit permission for such operations to be performed.

The content generator 102 can determine user profile data associated with a user in various ways, such as by using a unique identifier associated with a user who is viewer of the media content (e.g., a username that the user may use when logging into the an account used to view the media content) as a basis to select and obtain corresponding user profile data from a user profile database.

### D. Identifying a First Set of Segments

The content generator 102 can then identify from the obtained first media content, a first set of segments. What constitutes a segment in this context can vary depending on the desired configuration. As noted above, in some examples, each segment can represent a scene (or perhaps multiple scenes or portions thereof) of the media content. Generally, a scene may be characterized as a collection of shots that may be related in action, place, context, and/or time, with such relationship perhaps corresponding to the nature of the media content.

The content generator 102 can identify segments in various ways. For example, the content generator 102 can do this by employing a machine learning technique, such as one that uses a deep neural network (DNN) to train a segment identification model to use a runtime input-data set that includes media data to generate a runtime output-data set that includes segment identification data.

Notably though, before the content generator 102 uses a model to analyze a runtime input-data set to generate a runtime output-data set, the content generator 102 can first train the model by providing it with training input-data sets and training output-data sets. Each of the training input-data sets can include media data for media content, and each of the training output-data sets can include segment identification data. The segment identification data can take various forms. For instance, the segment identification data could be a data set that identifies segments by way of a starting and editing frame marker or the like for each segment.

In practice, it is likely that large amounts of training data—perhaps thousands of training data sets or more—would be used to train the model as this generally helps improve the usefulness of the model. Training data can be generated in various ways, including by being manually assembled. However, in some cases, the one or more tools or techniques, including any training data gathering or organization techniques now known or later discovered, can be used to help automate or at least partially automate the process of assembling training data and/or training the model. In some cases, synthetically generated media content can be used to help train the model. In this way, the content generator 102 can use any synthetic media content generation techniques now known or later discovered, to generate media content having multiple segments. Since the content generator 102 is generating the media content itself, it can determine where the each segments begins and ends, and as such, it can provide not only the generated media content, but also corresponding segment identification data to the model for training purposes.

After the model is trained, the content generator 102 can then provide to the model runtime input data, which the model can use to generate runtime output data. Generally, the runtime input data is of the same type as the training input data as described above. In this way, identifying from the obtained first media content, a first set of segments can involve providing at least the obtained first media content to a segment identification model and responsively receiving from the segment identification model, segment identification data that identifies the first set of segments.

The content generator 102 can also identify segments in other ways. For example, the content generator 102 can do so by employing one or more scene identification techniques now known or later discovered. Examples of such techniques include those described in U.S. Pat. No. 6,738,100 entitled “Method for detecting scene changes in a digital video stream,” U.S. Pat. No. 5,459,517 entitled “Moving picture scene detection system,” and U.S. Pat. No. 6,539,055 entitled “Scene change detector for video data.”

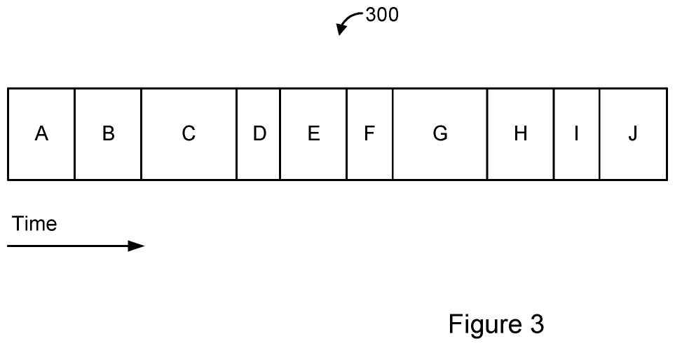

FIG. 3 is a simplified diagram illustrating an example set of segments identified from example media content. Specifically, FIG. 3 shows a first set of segments, namely ten segments A, B, C, D, E, F, G, H, I, and J, identified from the obtained first media content 302. The segments are shown in sequence, such that the obtained first media content begins with segment A, and is followed segment B, and then segment C, and so on. The obtained first media content is depicted in view of an axis representing time. Generally, the size of each segment represents its duration, such that a relatively narrow segment has a relatively short duration, and a relatively wide segment has a relatively long duration. This example is provided for illustration purposes only. In practice, in the case of certain media content like a movie or television show, the media content is likely to have many more scenes/segments, perhaps hundreds or more. Generally, many other examples (with different number of segments, of different durations, etc.) are possible as well.

### E. Determining Segment Relevance Data

Next, the content generator 102 can use at least (i) the obtained plot data, (ii) the obtained user profile data, and (iii) segment data associated with each segment of the identified first set of segments, to determine segment relevance data for each such segment.

Segment data can include various data related to a given segment. For example, segment data may include descriptive information about the content of the segment and could indicate, for example, who is in the scene, what happens in the scene, what dialog is spoken, what sound effects or music accompany the scene, among numerous other possibilities. The content generator 102 can obtain and/or generate this data in various ways. For example, this data could be stored as metadata with segments of the media content, in which case the content generator 102 can extract that metadata.

As another example, the content generate 102 can determine the segment data by leveraging one or more content recognition techniques (e.g., one that uses template matching and/or fingerprint-based identification techniques, or one that uses a suitably trained model) to detect various components of the segment, such as one or more objects, backgrounds, faces, etc. As another example, the content generator 102 can extract closed-captioning or subtitle data from the media content, which can include a text-based description of a subject of the segment. As yet another example, the content generator 102 can extract and process the audio content component of the segment, such as by providing the audio content to a natural language description model, which outputs a summary description of the text he audio, or perhaps by providing the audio content to a speech-to-text system to first generate text representing the speech, and then providing that text to a text analysis model, which outputs a summary description of the text, for instance. Segment data can include some or all of this or other data associated with a segment, or a perhaps a summarized, analyzed, or other type of processed version thereof. As still another example, the content generator 102 can leverage a large language model, such as the DeepMind model provided by Google LLC/Alphabet, Inc., to extract metadata that is representative of content in one or more components of one or more segments, which the content generator 102 can then compare to the obtained plot data, to determine segment relevance data for each such segment (e.g., perhaps by way of assigning each segment a relevance score within a given range as described below). The content generator 102 can also use such metadata for the purposes of generating voice-over narration or other audio that can help seamlessly bridge the gap between two segments when an intervening segment has been removed.

As discussed above, the content generator 102 can use at least the obtained plot data, the obtained user profile data, and segment data associated with each segment, to determine segment relevance data for each such segment. The content generator 102 can do this in various ways. Also, the segment relevance data can have one or more different components, including plot relevance data and user relevance data, for example.

In some examples, the content generator 102 using at least the obtained plot data, the obtained user profile data, and segment data associated with each segment, to determine segment relevance data for each such segment can involve the content generator 102 comparing the obtained plot data with the segment data associated with each segment, to determine plot relevance data. For example, in the case where the plot of a movie relates to a bank robbery and a segment of the movie is associated with segment data indicating that the segment itself relates to a bank robbery (e.g., based on certain dialog, objects in the scene, etc.), the content generator 102 might determine plot relevance data for that segment, where the plot relevance data indicates that the segment is highly relevant to the plot. Alternatively, in the case of another segment of that same movie is associated with segment data that is not related to a bank robbery (or to another other major plot point), the content generator 102 might determine plot relevance data indicating that the segment is not very relevant to the plot.

The plot relevance data can be represented in various ways, such as by way of a relevance score within a given range (e.g., a score within a given range, such as from 1-100) or the like, to indicate the degree to which that segment is relevant to the plot of the media content. For instance, in the case where the first set of segments includes the ten segments, A, B, C, D, E, F, G, H, I, and J, the content generator 102 can compare the segment data from each segment against the obtained plot data to determine a respective plot relevance score for each segment, perhaps determining that the segments A, B, C, D, E, F, G, H, I, and J, have plot relevance scores of 96, 54, 91, 89, 7, 84, 17, 38, 92, 41, respectively, as one example.

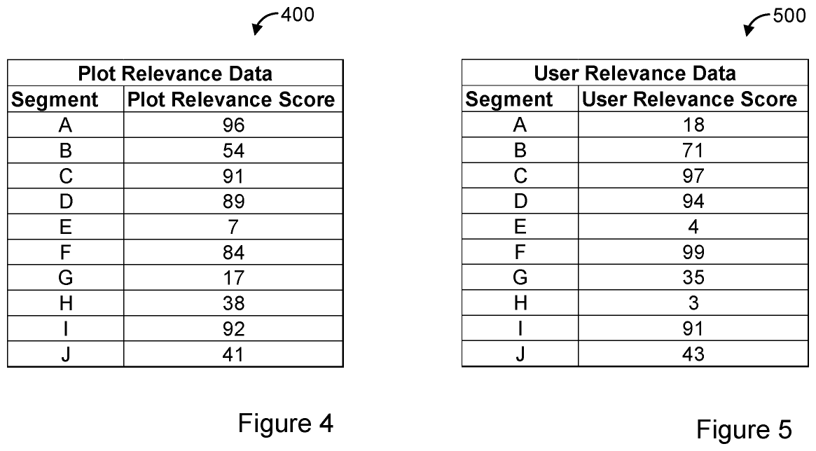

FIG. 4 is a simplified diagram illustrating example plot relevance data. In particular, FIG. 4 illustrates an example depiction of the above-described plot relevance data. As shown, the example plot relevance data 400 indicates plot relevance scores of 96, 54, 91, 89, 7, 84, 17, 38, 92, 41 for each of the segments A, B, C, D, E, F, G, H, I, and J, respectively.

In some examples, the content generator 102 can train and use a similarity analysis model to determine plot relevance data, such as by using plot data and segment data as input, to generate plot relevance scores or other plot relevance data as output. However, other techniques for comparing data and generating plot relevance data could be used as well. For example, the content generator 102 could use one or more mapping tables to maps certain pairs of plot data and segment data to certain plot relevance data, for instance.

In some examples, the content generator 102 using at least the obtained plot data, the obtained user profile data, and segment data associated with each segment, to determine segment relevance data for each such segment can involve the content generator 102 comparing the obtained user profile data with the segment data associated with each segment, to determine user relevance data. For example, in the case where user profile data indicates that a user prefers media content of a given genre and/or that has a given actor/address, and a given segment has segment data indicating that the segment has characteristic of that genre or that it has that actor/actress is in, the content generator 102 might determine user relevance data indicating that the segment is highly relevant to the user (i.e., highly relevant to the user's preferences). Alternatively, in the case where user profile data indicates that a user prefers media content of a different genre type and/or with a different actor/actress, the content generator 102 might determine user relevance data indicating that the segment is not very relevant to the user.

The user relevance data can be represented in various ways, such as by way of a relevance score within a given range (e.g., a score within a given range, such as from 1-100) or the like, to indicate the degree to which that segment is relevant to the user of the media content. For instance, in the case where the first set of segments includes ten segments, A, B, C, D, E, F, G, H, I, and J, the content generator 102 can compare the segment data from each segment against the obtained user profile data to determine a respective user relevance score for each segment, perhaps determining that the segments A, B, C, D, E, F, G, H, I, and J, have user relevance scores of 18, 71, 97, 94, 4, 99, 35, 3, 91, and 43, respectively. FIG. 5 is a simplified diagram illustrating example user relevance data. In particular, FIG. 5 illustrates an example depiction of the above-described user relevance data. As shown, the example user relevance data 500 indicates user relevance scores of 18, 71, 97, 94, 4, 99, 35, 3, 91, and 43 for each of the segments A, B, C, D, E, F, G, H, I, and J, respectively.

In some examples, the content generator 102 can train and use a similarity analysis model to determine user relevance data, such as by using user profile data and segment data as input, to generate user relevance scores or other user relevance data as output. However, other techniques for comparing data and generating user relevance data could be used as well. For example, the content generator 102 could use one or more mapping tables to maps certain pairs of user data and segment data to certain user relevance data, for instance.

In some examples, the content generator 102 can determine and/or use other data in connection with determining segment relevance data. For example, the content generator 102 can determine popularity data and/or spoiler data associated with a given segment, as a factor in determining the segment relevance data for a given segment. Popularity data can indicate an extent of popularity across one or more users. The content generator 102 can determine this in various ways, such as by analyzing news articles, television program or movie review platforms, social media platforms, etc. to determine an extent of general user interest in one or more segments of the media content. In cases where a given segment is relatively popular, that could be an additional factor that may weight in favor of the segment having a high plot or user relevance score. Conversely, in cases where a given segment is relatively unpopular, that could be an additional factor that may weight in favor of the segment having a low plot or user relevance score.

Spoiler data can indicate an extent to which a given segment may considered a spoiler (i.e., giving away a key plot point that might generally be omitted from a trailer or the like). The content generator 102 can likewise determine this in various ways, such as by analyzing news articles, television program or movie review platforms, social media platforms, etc. to determine an extent to which the segment is considered to be or include spoiler-type content. In cases where a given segment is considered to be or include spoiler content, that could be an additional factor that may weight in favor of the segment having a low plot or user relevance score (to lessen the chance that the segment is selected for use in generating second media content, as discussed below). Conversely, in cases where a given segment is not considered to include spoiler-type content, that could be an additional factor that may weight in favor of the segment having a high plot or user relevance score.

### F. Selecting a Second Set of Segments

Next, the content generator 102 can use at least the determined segment relevance data for the segments in the identified first set of segments as a basis to select, from among the identified first set of segments, a second set of segments having fewer segments than the first set of segments. The content generator 102 can do this in various ways, such as by selecting segments in the identified first set of segments that have plot relevance data and/or user relevance data that meets certain criteria, to be included in the second set of segments.

In some examples, this can involve the content generator 102 selecting segments in the identified first set of segments that have threshold high plot relevance scores and/or threshold high user relevance scores, to be included in the second set of segments. For example, returning to the example above where segments A, B, C, D, E, F, G, H, I, and J, have plot relevance scores of 96, 54, 91, 89, 7, 84, 17, 38, 92, 41, respectively, the content generator 102 could select segments having threshold high user relevance scores of 90 or above, such that the content generator 102 would select segments A, C, and I. In an alternative example, the content generator 102 could be configured such that it selects a certain number of segments having the highest plot relevance scores.

In other examples, the content generator 102 selecting the second set of segments can involve the content generator 102 selecting segments in the identified first set of segments that have threshold high user relevance scores, to be included in the second set of segments. For example, returning to the example above where segments A, B, C, D, E, F, G, H, I, and J, have user relevance scores of 18, 71, 97, 94, 4, 99, 35, 3, 91, and 43, respectively, the content generator 102 could select segments having threshold high user relevance scores of 90 or above, such that the content generator 102 would select segments C, F, D, and I. In an alternative example, the content generator 102 could be configured such that it selects a certain number of segments having the highest user relevance scores.

In some cases, the content generator 102 can use both the plot relevance data and the user relevance data components of the segment relevance data in selecting segments, perhaps with certain weights applied to each, as segment selection criteria. In this way, even though a given segment has just a moderate plot relevance score, the content generator 102 might nonetheless select that segment because it has a very high user relevance score, as just one example. As another example, even though a given segment has just a moderate user relevance score, the content generator 102 might nonetheless select that segment because it has a very high plot relevance score.

The content generator 102 can also consider other factors in making such selections, such as factors related to the number of segments to be selected, the duration of a selected segment or the combined duration of all segments selected, as just a few examples. For instance, the content generator 102 could further be configured to select between three and five segments, each having a duration that is between ten and thirty seconds, such that the total duration is between sixty second and ninety seconds, for instance. As another example, in the case where the content generator 102 is selecting segments to generate a trailer, it might be desirable to select a second set of segments where the combined duration of all segments is at or about sixty seconds, ninety seconds, or some other common trailer duration. The content generator 102 can consider various other factors as well. For instance, the content generator 102 might seek to select segments that are spaced out a certain amount within the obtained first media content, or that have collectively have a certain balance as far as types of segments in different settings, with different actors, etc.

The content generator 102 could be configured in lots of different ways to use the determined segment relevance data and/or other data to select segments, with the application of various weights, rules, etc., to provide flexibility depending on the desired configuration. For the purposes of illustrating examples of additional operations discussed below, it can be assumed that, for the segments A, B, C, D, E, F, G, H, I, and J, the content generator 102 selects segments A, C, F, and I, to be the segments of the second set of segments.

### G. Generating Second Media Content

Next, the content generator 102 can use at least the selected second set of segments to generate second media content, which can include a video content component and/or an audio content component, and where the generated second media content is shorter in duration than the obtained first media content.

The content generator 102 can generate the second media content in various ways. For example, this can involve the content generator 102 concatenating the segments of the selected second set of segments, according to an original sequence of the segments (i.e., the sequence of the segments as they were within the obtained first media content), to generate the second media content. This is sometimes referred to as stitching media content segments together, such that the multiple segments are combined into one larger instance of media content. In connection with concatenating segments of media content, the content generator 102 can employ any media content concatenation/stitching techniques now known or later discovered.

In some cases, it may be desirable to edit one or more of the segments in connection with the concatenation process. For example, in the case where it is desirable to generate second media content that is a particular duration (e.g., sixty or ninety seconds), the content generator 102 can truncate portions some or all of the component, as needed, to achieve that desired duration.

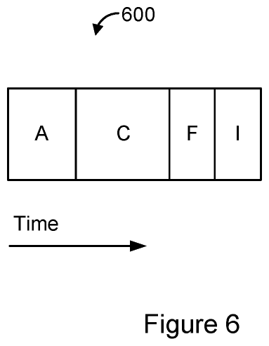

FIG. 6 is a simplified diagram illustrating example generated media content. In particular, FIG. 6 illustrates an example of generated second media content, based on an example in which the identified second set of segments include segments A, C, F, and I in their original sequence. As shown, the generated second media content 600 includes segments A, C, F, and I (but not the other segments of the obtained first media content). This example is provided for illustration purposes only. In practice, in the case of certain media content like a trailer for a movie or television program, the trailer is likely to have many more scenes/segments, perhaps dozens or more. Generally, many other examples (with different number of segments, of different durations, etc.) are possible as well.

In some cases, it may be desirable to change the order of the segments such that they are not in sequence as they were within the obtained first media content. For instance, in the case of the example where the generated second media content 600 includes segments A, C, F, and I, they may be ordered in that same way as A, C, F, I, or differently, perhaps as F, C, A, I, as one possibility among many others. The content generator 102 can consider various factors, such as the segment data associated with each segment to determine an appropriate order. For instance, the content generator 102 might seek to order segments in such a way so that the segments are spaced out a certain amount within the second media content, or that have collectively have a certain balance as far as types of segments in different settings, with different actors, etc.

In the case where the media content includes both a video content component and an audio content component, the content generator 102 concatenating the segments of the selected second set of segments can involve concatenating segments that themselves each include a video content component and an audio content component. However, is other examples, the content generator 102 can concatenate just the video component portions, and then add alternate audio content to the concatenated video. In this way, the content generator 102 can add alternate audio content (e.g., that includes music content and/or voiceover content, for example) to the concatenated video content, to generate the resulting second media content, where the alternate audio content spans multiple segments of the generated second media content.

In some examples, the content generator 102 can use various data, such as the plot data, the plot reference data, the user profile data, and/or the user reference data as a basis to select alternate audio content that may be suitable for use in the generated second media content. Also, in some cases, the content generator 102 can generate the alternate content so that it can be used for this purpose. In one example, the content generator 102 can provide a text-based narrative form of the plot data to a narration model, which can generate an audio content version of the narrative, and which the content generator 102 can use as a voiceover over at least a portion of the concatenated video content, for example.

### H. Outputting the Generated Second Media Content

Next, the content generator 102 can output the generated second media content for presentation. The content generator 102 can do this in various ways. In one example, this can include the content-distribution system 106 transmitting the generated second media content to the content-presentation device 108, which can receive and itself output for presentation the generated second media content, such that it can be viewed by a user.

The content-distribution system 106 can transmit media content on one or more channels (sometimes referred to as stations or feeds). As such, the content-distribution system 106 can be associated with a single channel content distributor or a multi-channel content distributor such as a multi-channel video program distributor (MVPD).

The content-distribution system 106 and its means of transmission of media content on the channel to the content-presentation device 108 can take various forms. By way of example, the content-distribution system 106 can be or include a cable-television head-end that is associated with a cable-television provider and that transmits the media content on the channel to the content-presentation device 108 through hybrid fiber/coaxial cable connections. As another example, the content-distribution system 106 can be or include a satellite-television head-end that is associated with a satellite-television provider and that transmits the media content on the channel to the content-presentation device 108 through a satellite transmission. As yet another example, the content-distribution system 106 can be or include a television-broadcast station that is associated with a television-broadcast provider and that transmits the content on the channel through a terrestrial over-the-air interface to the content-presentation device 108. And as yet another example, the content-distribution system 106 can be an Internet-based distribution system that transmits the media content using a media content streaming-characteristic service or the like to the content-presentation device 108.

In these and other examples, the content-distribution system 106 can transmit the content in the form of an analog or digital broadcast stream representing the media content.

The content-presentation device 108 can receive media content from one or more entities, such as the content-distribution system 106. In one example, the content-presentation device 108 can select (e.g., by tuning to) a channel from among multiple available channels, perhaps based on input received via a user interface, such that the content-presentation device 108 can receive media content on the selected channel.

In some examples, the content-distribution system 106 can transmit media content to the content-presentation device 108, which the content-presentation device 108 can receive. The content-presentation device 108 can also output media content for presentation. As noted above, the content-presentation device 108 can take various forms. In one example, in the case where the content-presentation device 108 is a television (perhaps with an integrated set-top box and/or streaming media device), outputting the media content for presentation can involve the television outputting the media content via a user interface (e.g., a display device and/or a sound speaker), such that it can be presented to an end-user. As another example, in the case where the content-presentation device 108 is a set-top box or a streaming media device, outputting the media content for presentation can involve the set-top box or the streaming media stick outputting the media content via a communication interface (e.g., an HDMI interface), such that it can be received by a television and in turn output by the television for presentation to an end-user.

As such, in various scenarios, the content-distribution system 106 can transmit media content to the content-presentation device 108, which can receive and output the media content for presentation to an end-user.

### I. Editing System

In some instances, the content system 100 can include an editing system component that allows a user to review, approve, reject, and/or edit various operations or results of operations, as part of a quality assurance process. For instance, in the context of the content generator 102 identifying the first set of segments, determining segment relevance data, selecting the second set of segments, and/or generating the second media content, the editing system can provide suggested determinations, selections, etc. that allows a user of the editing system to review and approve (perhaps with some user input/editing). Notably, such a user interfacing with the editing system could be an end-user, or perhaps a user tasked with producing/editing media content so that it can be provided to an end-user, for example.

### J. Example Use Cases

The examples and use cases described herein have been provided for purposes of illustration and are not limiting. Indeed, the disclosed techniques could be applied in connection with lots of different examples and use cases, to generate all different types of summarized media content in various situations. For example, the disclosed techniques could be used to generate a trailer or the like for a movie or a television program (including for a given television program episode, season of episodes, etc.). In some cases, the generated second media content could take the form of a typical trailer (e.g., intended for promotional purposes, etc.), but in other cases, the generated second media content can be used for other purposes as well, such as to serve as a “previously on” montage that is intended to help get a user up-to-speed on past television program episodes, seasons, etc. or earlier movies in a series of movies, for example. Various other example use cases are possible as well.

### K. Example Methods

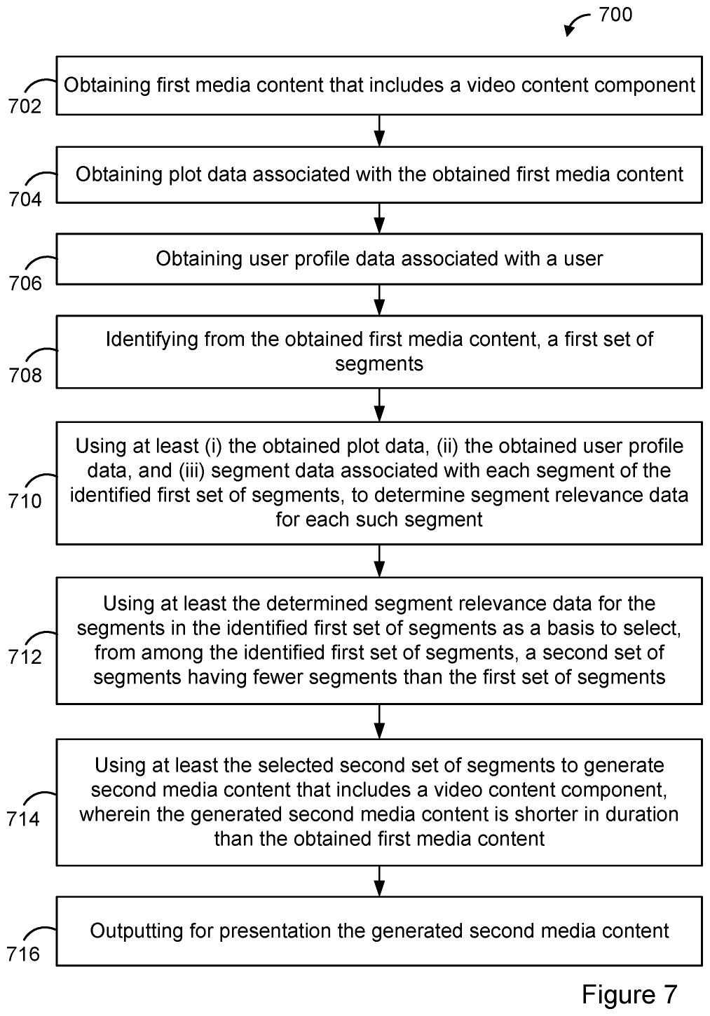

FIG. 7 is a flow chart illustrating an example method 700. The method 700 can be carried out by a content system, such as the content system 100, the content generator 102, or more generally, by a computing system, such as the computing system 200. At block 702, the method 700 includes obtaining first media content that includes a video content component. At block 704, the method 700 includes obtaining plot data associated with the obtained first media content. At block 706, the method 700 includes obtaining user profile data associated with a user. At block 708, the method 700 includes identifying from the obtained first media content, a first set of segments. At block 710, the method 700 includes using at least (i) the obtained plot data, (ii) the obtained user profile data, and (iii) segment data associated with each segment of the identified first set of segments, to determine segment relevance data for each such segment. At block 712, the method 700 includes using at least the determined segment relevance data for the segments in the identified first set of segments as a basis to select, from among the identified first set of segments, a second set of segments having fewer segments than the first set of segments. At block 714, the method 700 includes using at least the selected second set of segments to generate second media content that includes a video content component, wherein the generated second media content is shorter in duration than the obtained first media content. At block 716, the method 700 includes outputting for presentation the generated second media content.

In some examples, the plot data associated with the obtained first media content includes text summarizing a plot of the obtained first media content, and the user profile data includes (i) genre preference data and/or (ii) actor/actress preference data. In to some implementations, identifying from the obtained first media content, a first set of segments can involve providing at least the obtained first media content to a segment identification model and responsively receiving from the segment identification model, segment identification data that identifies the first set of segments.

In some examples, the determined segment relevance data for each such segment includes a plot relevance score for that segment and a user relevance score for that segment. And using at least the determined segment relevance data for the segments in the identified first set of segments as a basis to select, from among the identified first set of segments, a second set of segments having fewer segments than the first set of segments can involve selecting segments that have threshold high plot relevance scores and/or threshold high user relevance scores.

In some examples, using at least the selected second set of segments to generate second media content that includes a video content component comprises concatenating the segments of the selected second set of segments, according to an original sequence of the segments, to generate the second media content. In some implementations, the obtained first media content can further includes an audio content component, and using at least the selected second set of segments to generate second media content that includes a video content component can involve using both the video content component and the audio content component of the obtained first media content to generate the second media content.

In some examples, the obtained first media content further includes an audio content component, and using at least the selected second set of segments to generate second media content that includes a video content component involves using the video content component of the obtained first media content and alternate audio content different from the audio content component of the obtained first media content to generate the second media content. In some examples, the alternate audio content includes music content or voiceover content, and wherein the alternate audio spans multiple segments of the generated second media content. In various examples, the obtained first media content is a movie or a television program and the generated second media content is a trailer for that movie or television program.

According to some implementations, outputting for presentation, the generated second media content can involve transmitting to a presentation device, media data representing the generated modified media content for display by the presentation device.

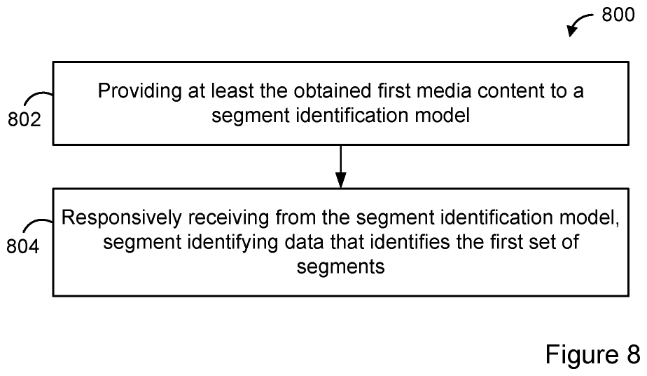

FIG. 8 is a flow chart illustrating an example method 800 for identifying from the obtained first media content, a first set of segments. The method 800 can be carried out by a content system, such as the content system 100, the content generator 102, or more generally, by a computing system, such as the computing system 200. At block 802, the method 800 includes providing at least the obtained first media content to a segment identification model. At block 804, the method 800 includes responsively receiving from the segment identification model, segment identification data that identifies the first set of segments.

### IV. Example Variations

Although some of the acts and/or functions described in this disclosure have been described as being performed by a particular entity, the acts and/or functions can be performed by any entity, such as those entities described in this disclosure. Further, although the acts and/or functions have been recited in a particular order, the acts and/or functions need not be performed in the order recited. However, in some instances, it can be desired to perform the acts and/or functions in the order recited. Further, each of the acts and/or functions can be performed responsive to one or more of the other acts and/or functions. Also, not all of the acts and/or functions need to be performed to achieve one or more of the benefits provided by this disclosure, and therefore not all of the acts and/or functions are required.

Although certain variations have been discussed in connection with one or more examples of this disclosure, these variations can also be applied to all of the other examples of this disclosure as well.

Although select examples of this disclosure have been described, alterations and permutations of these examples will be apparent to those of ordinary skill in the art. Other changes, substitutions, and/or alterations are also possible without departing from the invention in its broader aspects as set forth in the following claims.

1. A method comprising:
obtaining first media content that includes a video content component;
obtaining plot data associated with the obtained first media content;
obtaining user profile data associated with a user;
identifying from the obtained first media content, a first set of segments;
using at least (i) the obtained plot data, (ii) the obtained user profile data, and (iii) segment data associated with each segment of the identified first set of segments, to determine segment relevance data for each such segment;
using at least the determined segment relevance data for the segments in the identified first set of segments as a basis to select, from among the identified first set of segments, a second set of segments having fewer segments than the first set of segments;
using at least the selected second set of segments to generate second media content that includes a video content component, wherein the generated second media content is shorter in duration than the obtained first media content; and
outputting for presentation the generated second media content.

2. The method of claim 1, wherein the plot data associated with the obtained first media content comprises text summarizing a plot of the obtained first media content.

3. The method of claim 1, wherein the user profile data comprises (i) genre preference data and/or (ii) actor/actress preference data.

4. The method of claim 1, wherein identifying from the obtained first media content, a first set of segments comprises:
providing at least the obtained first media content to a segment identification model; and
responsively receiving from the segment identification model, segment identification data that identifies the first set of segments.

5. The method of claim 1, wherein the determined segment relevance data for each such segment includes a plot relevance score for that segment and a user relevance score for that segment.

6. The method of claim 1, wherein using at least the determined segment relevance data for the segments in the identified first set of segments as a basis to select, from among the identified first set of segments, a second set of segments having fewer segments than the first set of segments comprises selecting segments that have threshold high plot relevance scores and/or threshold high user relevance scores.

7. The method of claim 1, wherein using at least the selected second set of segments to generate second media content that includes a video content component comprises concatenating the segments of the selected second set of segments, according to an original sequence of the segments, to generate the second media content.

8. The method of claim 1, wherein the obtained first media content further includes an audio content component, and wherein using at least the selected second set of segments to generate second media content that includes a video content component comprises using both the video content component and the audio content component of the obtained first media content to generate the second media content.

9. The method of claim 1, wherein the obtained first media content further includes an audio content component, and wherein using at least the selected second set of segments to generate second media content that includes a video content component comprises using the video content component of the obtained first media content and alternate audio content different from the audio content component of the obtained first media content to generate the second media content.

10. The method of claim 9, wherein the alternate audio content includes music content or voiceover content, and wherein the alternate audio content spans multiple segments of the generated second media content.

11. The method of claim 1, wherein the obtained first media content is a movie or a television program and the generated second media content is a trailer for that movie or television program.

12. The method of claim 1, wherein outputting for presentation, the generated second media content comprises transmitting to a presentation device, media data representing the generated modified media content for display by the presentation device.

13. A computing system configured for performing a set of acts comprising:
obtaining first media content that includes a video content component;
obtaining plot data associated with the obtained first media content;
obtaining user profile data associated with a user;
identifying from the obtained first media content, a first set of segments;
using at least (i) the obtained plot data, (ii) the obtained user profile data, and (iii) segment data associated with each segment of the identified first set of segments, to determine segment relevance data for each such segment;
using at least the determined segment relevance data for the segments in the identified first set of segments as a basis to select, from among the identified first set of segments, a second set of segments having fewer segments than the first set of segments;
using at least the selected second set of segments to generate second media content that includes a video content component, wherein the generated second media content is shorter in duration than the obtained first media content; and
outputting for presentation the generated second media content.

14. The computing system of claim 13, wherein the plot data associated with the obtained first media content comprises text summarizing a plot of the obtained first media content.

15. The computing system of claim 13, wherein the user profile data comprises (i) genre preference data and/or (ii) actor/actress preference data.

16. The computing system of claim 13, wherein identifying from the obtained first media content, a first set of segments comprises:
providing at least the obtained first media content to a segment identification model; and
responsively receiving from the segment identification model, segment identification data that identifies the first set of segments.

17. The computing system of claim 13, wherein the determined segment relevance data for each such segment includes a plot-relevance score for that segment and a user-relevance score for that segment.

18. The computing system of claim 13, wherein using at least the determined segment relevance data for the segments in the identified first set of segments as a basis to select, from among the identified first set of segments, a second set of segments having fewer segments than the first set of segments comprises selecting segments that have threshold high plot-relevance scores and/or threshold high user-relevance scores.

19. The computing system of claim 13, wherein the obtained first media content further includes an audio content component, and wherein using at least the selected second set of segments to generate second media content that includes a video content component comprises using both the video content component and the audio content component of the obtained first media content to generate the second media content.

20. A non-transitory computer-readable medium having stored thereon program instructions that upon execution by a processor of a computing system, cause performance of a set of acts comprising:
obtaining first media content that includes a video content component;
obtaining plot data associated with the obtained first media content;
obtaining user profile data associated with a user;
identifying from the obtained first media content, a first set of segments;
using at least (i) the obtained plot data, (ii) the obtained user profile data, and (iii) segment data associated with each segment of the identified first set of segments, to determine segment relevance data for each such segment;
using at least the determined segment relevance data for the segments in the identified first set of segments as a basis to select, from among the identified first set of segments, a second set of segments having fewer segments than the first set of segments;
using at least the selected second set of segments to generate second media content that includes a video content component, wherein the generated second media content is shorter in duration than the obtained first media content; and
outputting for presentation the generated second media content.
